(19) United States
(12) Patent Application Publication
(10) Pub. No.: US 2013/0117937 A1
(43) Pub. Date: May 16, 2013

(54) SYSTEM FOR INCLINING A SURFACE

(71) Applicant: Daniel Beaton, Ossining, NY (US)

(72) Inventor: Daniel Beaton, Ossining, NY (US)

(21) Appl. No.: 13/293,609

(22) Filed: Nov. 10, 2011

(51) Int. Cl. A61G 7/005; F16M 13/00; A47C 7/02

(52) U.S. Cl. 5/610; 297/452.48; 248/694; 248/346.01

(57) ABSTRACT

One example embodiment includes a system for inclining a surface. The system includes a support. The support includes a first end and a second end, where the second end is higher than the second end.

### CROSS-REFERENCE TO RELATED APPLICATIONS

Not applicable.

### BACKGROUND OF THE INVENTION

Elevation of the head or legs while resting or sleeping is a recommended remedy for a variety of ailments, such as spinal cord injury, back pain, acid reflux or Gastroesophageal Reflux Disease (GERD), sinus and respiratory disorders, sleep apnea, poor circulation, low metabolism, edema in the legs, and many other conditions. Such a remedy is sometimes referred to as Inclined Bed Therapy (IBT). Sleeping at an incline in which the head is raised at an even incline anywhere from 3″ to 8″ higher than the legs is a method proven to help with many physical conditions.

However, to date, the solutions available are some combination of (i) not adjustable; (ii) not suitable for use with mattresses of different sizes (iii) expensive; (iv) not easily portable; and (v) not aesthetically pleasing. For example, some people place blocks or other similar mechanisms between the bedframe and the floor in order to raise the head of the bed frame up higher off the floor. However, this method results in the headboard being tilted away from the wall and bottom of any bed skirt to no longer be parallel to the floor, which is an aesthetically non-pleasing solution. It is also a solution that requires either significant strength from a single person or multiple people to implement. This solution is also not useful in a bunk-bed situation in which one desires to raise the head or feet of one of the beds in the bunk bed system but not the other (or to set each bed in the bunk bed system to a different incline). In addition, this method can nullify mattress warranties in the event of a faulty mattress claim.

Another solution is to purchase a mechanical bed with build-in mechanisms for raising the head or feet of the bed. This solution, however, if expensive and narrows the field of available mattresses that one can purchase. It is also not a portable solution that allows one to benefit from the inclined bed therapy while traveling.

Another solution is to place an inclined surface on top of the bed. For example, the user can purchase a “mattress topper” or other product that is placed on top of the mattress. However, this changes the sleeping surface on which the user is resting. I.e., if the inclined surface is “firm” and the mattress is “soft”, or vice versa, then the user must trade his/her preferred sleeping surface for one which inclined. Therefore, the user may need to choose between a preferred sleeping surface and the benefits of an inclined mattress.

Accordingly, a need still exists for a portable and inexpensive system which allows (i) one to evenly incline a mattress without sacrificing the aesthetic qualities of how a bed frame is positioned relative to a wall and floor; (ii) one bed in a bunk bed system to be so adjusted without adjusting the same end of the other bed in the bunk system; and (iii) not nullify the warranty of the mattress.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for inclining a surface. The system includes a support. The support includes a first end and a second end, where the second end is higher than the second end.

Another example embodiment includes a system for inclining a surface. The system includes a first support. The first support includes a first end and a second end, where the second end is higher than the second end. The system also includes a second support. The second support includes a first end and a second end, where the second end is higher than the second end.

Another example embodiment includes a system for inclining a surface. The system includes a foundation and a first support. The first support includes a first end and a second end, where the second end is higher than the second end. At least a portion of the first support is on top of the foundation. The system also includes a second support. The second support includes a first end and a second end, where the second end is higher than the second end. At least a portion of the second support is on top of the foundation. The system further includes a gap, where the gap is between at least a portion of the first support and the second support. The system additionally includes a mattress. The mattress covers at least a portion of the first support, the second support and the gap.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of the example of the system for inclining a surface;

FIG. 1B illustrates a top view of the example of the system for inclining a surface;

FIG. 2A illustrates a side view of the alternative example of the system for inclining a surface;

FIG. 2B illustrates a top view of the alternative example of the system for inclining a surface;

FIG. 3 illustrates the system of FIGS. 2A and 2B with she supports adjusted;

FIG. 4 illustrates an alternative example of a system for inclining a surface;

FIG. 5 illustrates an alternative example of the system for inclining a surface; and

FIG. 6 illustrates an alternative example of the system for inclining a surface.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

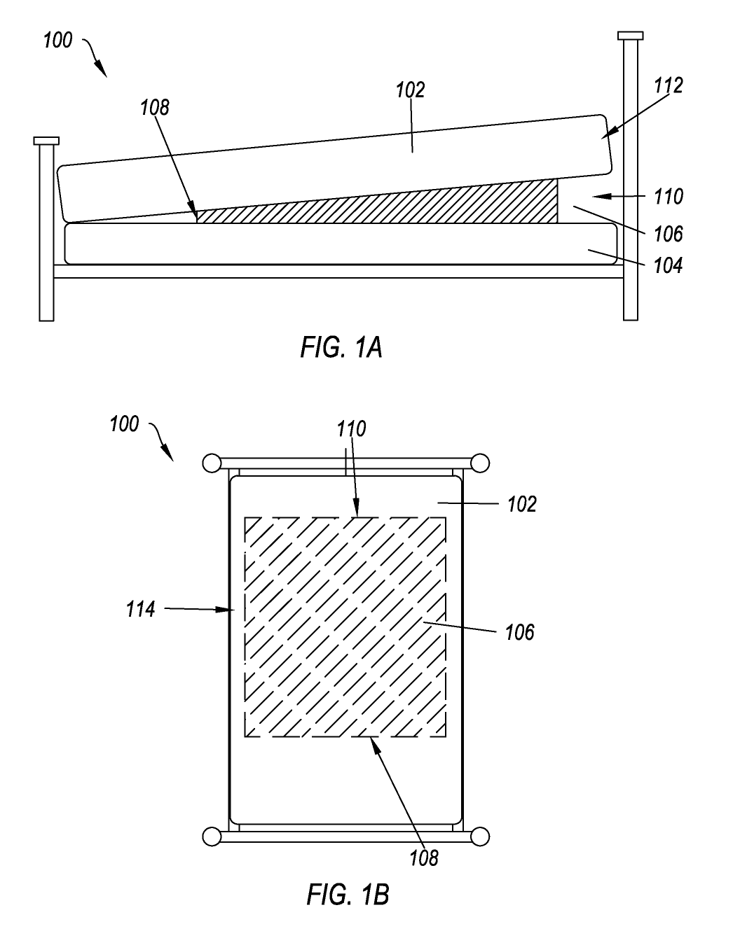

FIGS. 1A and 1B illustrate an example of a system 100 for inclining a surface. FIG. 1A illustrates a side view of the example of the system 100 for inclining a surface; and FIG. 1B illustrates a top view of the example of the system 100 for inclining a surface. One of skill in the art will appreciate that inclining, as used herein, can include elevating some or all of the surface. Although a sleeping surface is used as exemplary herein, one of skill in the art will appreciate that the system 100 can be used for inclining any desired surface. For example, the system 100 can be used for inclining a couch cushion or other desired surface.

FIGS. 1A and 1B show that the system 100 can be used with a mattress 102. In at least one implementation, the mattress 102 can include a manufactured product to sleep or lie on. In particular, the mattress 102 can include resilient materials covered with an outer fabric or ticking. The resilient materials can include natural materials such as straw, feathers or horse hair, an inner spring core or materials such as latex, viscoelastic or other flexible polyurethane foams. Other fill components can include insulator pads over the coils that prevent the bed's upholstery layers from cupping down into the innerspring, as well as polyester fiberfill in the bed's top upholstery layers. Mattresses may also be filled with air or water, or a variety of natural fibers, such as in futons.

FIGS. 1A and 1B also show that the system 100 can include a foundation 104. In at least one implementation, the foundation 104 can provide a base or support for the mattress 102. The foundation 104 may be solid, as in the case of a platform bed, or elastic, e.g. with an upholstered wood and wire box spring or a slatted foundation).

FIGS. 1A and 1B further show that the system 100 can include a support 106. In at least one implementation, the support 106 can allow a user to incline a mattress 102 at a desired angle. In particular, the support 106 can allow the user to select a height at which the user would like the mattress 102 to be inclined. I.e., the user can elevate the mattress 102 the desired amount, as described below. The support 106 can be made of any desired material. For example, the support 106 can be made of polystyrene foam, polyurethane foam, wood, metal or any other material. One of skill in the art will appreciate that the support 106 can be placed underneath the mattress 102. This allows the user to sleep on the mattress 102 instead of the support 106. I.e., the support 106 can allow the user to incline a preferred surface, rather than be placed on top of the mattress 102, changing the surface that the user is in contact with.

Additionally or alternatively, the support 106 can include an inflatable material. In at least one implementation, the inflatable material can be filled with air or another gas or liquid. The inflatable material is inflated until full, providing structural support. The inflatable material constrains the air, which resists the force of gravity attempting to pull the mattress 102 lower due to the resistance of the air to compression. I.e., the support 106, without any air, is compact and easily transported but does not provide a high amount of support. In contrast, the support 106, when filled with air, is less compact; however, the constrained air provides a high amount of support.

FIGS. 1A and 1B additionally show that the support 106 can be placed between the mattress 102 and the foundation 104. In at least one implementation, placing the support 106 between the mattress 102 and the foundation 104 can allow the mattress 102 to be inclined relative to the foundation 104. In particular, the user can determine the amount of inclination, as described below.

FIGS. 1A and 1B also show that the support 106 can include a first end 108. In at least one implementation, the first end 108 can be between 1 and 3 inches tall. For example, the first end 108 can be approximately 2 inches tall. As used in the specification and the claims, the term approximately shall mean that the value is within 10% of the stated value, unless otherwise specified. Additionally or alternatively, the first end 108 can be between 1 inch and 19 inches wide. For example, the first end 108 can be approximately 16 inches wide.

FIGS. 1A and 1B further show that the support 106 can include a second end 110. In at least one implementation, the second end 110 can be taller than the first end 108. I.e., the support 106 can slope down from the second end 110 to the first end 108. For example, the second end 110 can be between 3 inches and 5 inches tall. E.g., the second end 110 can be approximately 4 inches tall. Additionally or alternatively, the second end 110 can be between 1 inch and 19 inches wide. For example, the second end 110 can be approximately 16 inches wide.

FIGS. 1A and 1B additionally show that the mattress 102 can include a first unsupported portion 112. In at least one implementation, a first unsupported portion 112 can include a portion of the mattress 102 which does not rest on the support 106. In particular, the first unsupported portion 112 can be near the first end 108 and the second end 110. The internal structure of the mattress 102 can support the portion of the mattress 102 not resting on the support 106. I.e., the first unsupported portion 112 of the mattress 102 can allow the user to adjust the inclination of the mattress 102. One of skill in the art will appreciate that to achieve an even incline, the user must move all of the supports 106 equally. I.e., if multiple supports 106 are used, the first unsupported portion 112 needs to be the same size near the first end 108 and the second end 110 to achieve an even incline.

One of skill in the art will appreciate that the differences in height between the first end 108 and the second end 110 in combination with the unsupported portion 112 of the mattress 102 can allow the user to change the incline. In particular, the support 106 can be moved toward the end of the mattress 102 near the first end 108 of the support 106 increasing the inclination. I.e., the larger the portion of the mattress 102 which is not supported by the support 106 near the second end 110, the greater the inclination. In contrast, the support 106 can be moved toward the end of the mattress 102 near the second end 110 of the support 106, decreasing the inclination.

FIGS. 1A and 1B also show that the support 106 can include a second unsupported portion 114. In at least one implementation, the second unsupported portion can be between the first end 108 and the second end 110. I.e., the second unsupported portion can be near the “side” of the support 106. In at least one implementation, the second unsupported portion 114 can allow two or more supports 106 to support the mattress 102. In particular, two or supports 106 can be placed under the mattress 102, depending on the size of the mattress. This can allow a single size of support 106 to be used to support all sizes of mattress 102, if so desired by the user. In particular, the second unsupported portion 114 can be any distance smaller than 8 inches, and the internal structure of the mattress 102 can prevent sagging of the mattress 102. For example, a “single” mattress is approximately 36 inches wide. Therefore, two supports 106 can be placed under the mattress with a two inch gap between the two supports 106 with the second unsupported portion being approximately 2 inches wide on either side of the mattress 102.

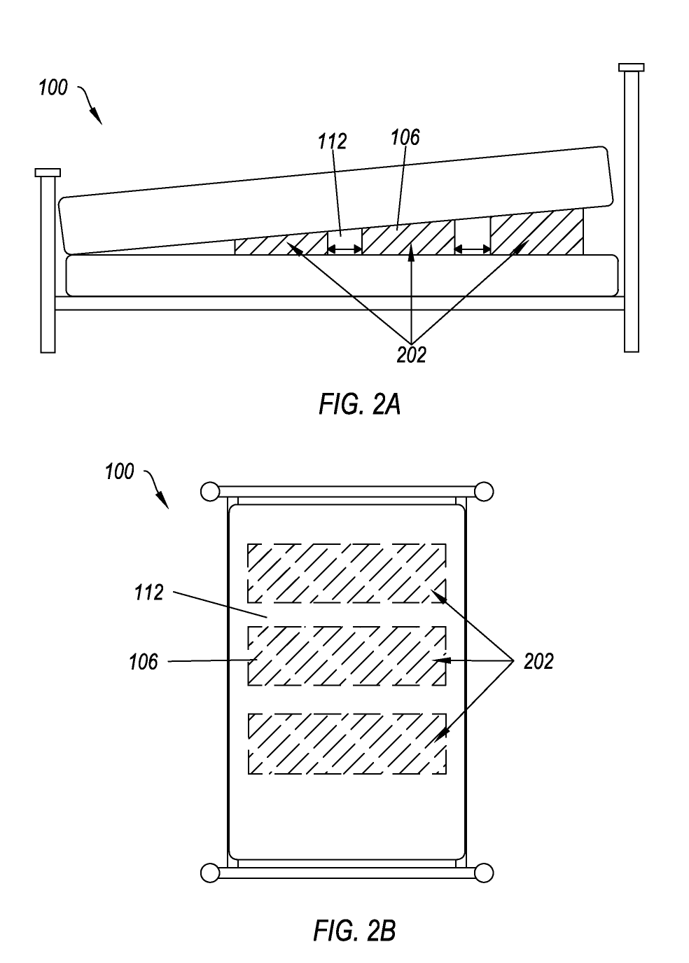

FIGS. 2A and 2B illustrate an alternative example of a system 100. FIG. 2A illustrates a side view of the alternative example of the system 100 for inclining a surface; and FIG. 2B illustrates a top view of the example of the system 100 for inclining a surface. Although a sleeping surface is used as exemplary herein, one of skill in the art will appreciate that the system 100 can be used for inclining any desired surface. For example, the system 100 can be used for inclining a couch cushion or other desired surface.

FIGS. 2A and 2B show that the system 100 can include a set of supports 202. In at least one implementation, the set of supports 202 can allow the user more control the incline of the bed. In particular, the set of supports 202 can allow the user to place smaller supports 106 where the user prefers less elevation and larger supports 106 where the user prefers more elevation. For example, smaller supports 106 can be placed near the foot of the mattress and larger supports 106 can be placed near the head of the mattress.

FIGS. 2A and 2B also show that the system 100 can include an unsupported portion 112 between the supports 106. As described above, the internal structure of the mattress can support the mattress 102 above the first unsupported portion 112. I.e., the supports 106 can adequately support the mattress 102 because the internal structure of the mattress 102 can allow the mattress to remain firm over small distances without support.

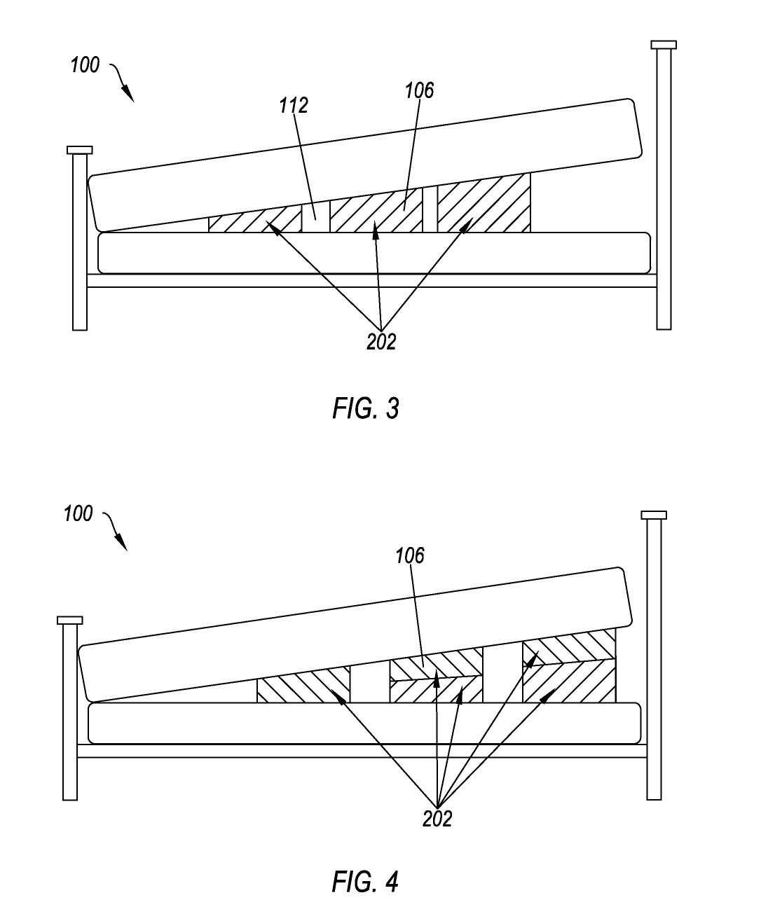

FIG. 3 illustrates the system 100 of FIGS. 2A and 2B with she supports 106 adjusted. I.e., FIG. 3 shows that the user need not get new supports in order to change the incline of the mattress 102. Instead, the user can modify the placement of the supports 106. This can allow the user to adjust the incline as desired without having to purchase additional supports 106. One of skill in the art will appreciate that the same adjustability is a feature of each of the supports 106 described in the application. In particular, the user can modify the size of the first unsupported portion 112 and the second unsupported portion 114 of the mattress 102 to adjust the incline of the mattress 102.

FIG. 4 illustrates an alternative example of a system 100 for inclining a surface. Although a sleeping surface is used as exemplary herein, one of skill in the art will appreciate that the system 100 can be used for inclining any desired surface. For example, the system 100 can be used for inclining a couch cushion or other desired surface.

FIG. 4 shows that the system 100 can include multiple supports 106 stacked atop one another. I.e., the system 100 can include a set of supports 202, with greater elevation achieved by stacking one or more supports 106 on top of additional supports 106.

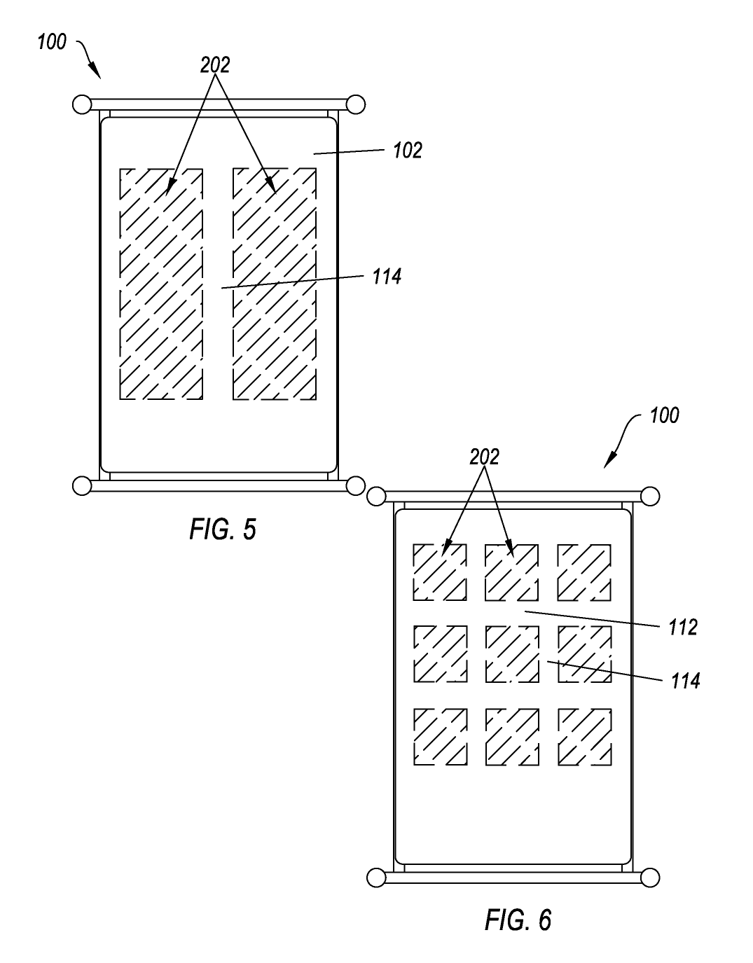

FIG. 5 illustrates an alternative example of the system 100 for inclining a surface. Although a sleeping surface is used as exemplary herein, one of skill in the art will appreciate that the system 100 can be used for inclining any desired surface. For example, the system 100 can be used for inclining a couch cushion or other desired surface.

FIG. 5 shows that the system 100 can include a set of supports 202. In at least one implementation, the set of supports 202 can allow the user to use a single size of support 106 to control the incline of the bed. In particular, the set of supports 202 can allow the user to place more supports 106 when the user has a larger mattress 102 and fewer supports 106 when the user has a smaller mattress 102. For example, two supports 106 can be placed under a single mattress 102 and three supports 106 can be placed under a queen sized mattress 102.

FIG. 5 also shows that the system 100 can include an unsupported portion 114 between the supports 106. As described above, the internal structure of the mattress can support the mattress 102 above the unsupported portion 114. I.e., the supports 106 can adequately support the mattress 102 because the internal structure of the mattress 102 can allow the mattress to remain firm over small distances without support, as described above.

FIG. 6 illustrates an alternative example of the system 100 for inclining a surface. Although a sleeping surface is used as exemplary herein, one of skill in the art will appreciate that the system 100 can be used for inclining any desired surface. For example, the system 100 can be used for inclining a couch cushion or other desired surface.

FIG. 6 shows that the system 100 can include a set of supports 202. In at least one implementation, the set of supports 202 can allow the user more control over the incline of the bed mattress 102. In particular, the set of supports 202 can allow the user to place smaller supports 106 where the user prefers less elevation and larger supports 106 where the user prefers more elevation. For example, smaller supports 106 can be placed near the foot of the mattress and larger supports 106 can be placed near the head of the mattress. Additionally or alternatively, the set of supports 202 can allow the user to use a single size of support 106 to control the incline of the bed. In particular, the set of supports 202 can allow the user to place more supports 106 when the user has a larger mattress 102 and fewer supports 106 when the user has a smaller mattress 102. For example, two supports 106 can be placed under a single mattress 102 and three supports 106 can be placed under a queen sized mattress 102.

FIG. 6 also show that the system 100 can include a first unsupported portion 112 and a second unsupported portion 114 between the supports 106. As described above, the internal structure of the mattress can support the mattress 102 above the first unsupported portion 112 a second unsupported portion 114. I.e., the supports 106 can adequately support the mattress 102 because the internal structure of the mattress 102 can allow the mattress to remain firm over small distances without support.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for inclining a surface, the system comprising:
a support, wherein the support includes:
a first end; and
a second end, wherein the second end is higher than the second end.

2. The system of claim 1 further comprising a mattress, wherein the mattress is placed on top of the support.

3. The system of claim 2, wherein the mattress includes an unsupported portion.

4. The system of claim 1 further comprising a foundation, wherein the support is placed on top of the foundation.

5. The system of claim 1 further comprising a cushion, wherein the cushion is placed on top of the support.

6. The system of claim 5, wherein the cushion includes a couch cushion.

7. The system of claim 1, wherein the support is inflatable.

8. The system of claim 1, wherein the support is between 1 inch and 19 inches wide

9. The system of claim 1, wherein the support is approximately 16 inches wide.

10. The system of claim 1, wherein the support is approximately trapezoidal in shape.

11. A system for inclining a surface, the system comprising:
a first support, wherein the first support includes:
a first end; and
a second end, wherein the second end is higher than the second end; and
a second support, wherein the second support includes:
a first end; and
a second end, wherein the second end is higher than the second end.

12. The system of claim 11, wherein the first end of the first support is higher than the second end of the second support.

13. The system of claim 11, wherein the first end of the first support is the same height as the first end of the second support.

14. The system of claim 11, wherein the first support is immediately adjacent the second support

15. The system of claim 11, wherein the first support and the second support are not in contact with one another.

16. A system for inclining a surface, the system comprising:
a foundation;
a first support, wherein:
the first support includes:
a first end; and
a second end, wherein the second end is higher than the second end; and
at least a portion of the first support is on top of the foundation;
a second support, wherein
the second support includes:
a first end; and
a second end, wherein the second end is higher than the second end; and
at least a portion of the second support is on top of the foundation;
a gap, wherein the gap is between at least a portion of the first support and the second support;
a mattress, wherein the mattress covers at least a portion of:
the first support;
the second support; and
the gap.

17. The system of claim 16, wherein the gap is less than 8 inches at its widest point.

18. The system of claim 16 further comprising:
a third support, wherein:
the third support includes:
a first end; and
a second end, wherein the second end is higher than the second end; and
at least a portion of the third support is on top of the foundation.

19. The system of claim 18, wherein:
the first end of the first support is higher than the second end of the second support; and
the first end of the second support is higher than the second end of the third support.

20. The system of claim 18, wherein:
the first end of the first support is the same height as the first end of the second support; and
the first end of the first support is the same height as the first end of the third support.
